(19) United States
(12) Patent Application Publication
(10) Pub. No.: US 2016/0048212 A1
(43) Pub. Date: Feb. 18, 2016

(54) Display Device and Control Method Thereof, and Gesture Recognition Method

(71) Applicant: BOE TECHNOLOGY GROUP CO., LTD., Beijing (CN)

(72) Inventor: Changlin LENG, Beijing (CN)

(21) Appl. No.: 14/421,044

(22) PCT Filed: May 21, 2014
(86) PCT No.: PCT/CN2014/078016

§ 371 Date: Feb. 11, 2015

(30) Foreign Application Priority Data
Oct. 31, 2013 (CN) 201310530739.9

(51) Int. Cl. G06F 3/01

(52) U.S. Cl. CPC G06F 3/017

(57) ABSTRACT

The present invention provides a display device and a control method thereof, and a gesture recognition method. The control method comprises steps of: displaying a control picture by a display unit, converting the control picture into a virtual 3D control picture and providing the virtual 3D control picture to a user, wherein a distance between the virtual 3D control picture and eyes of the user is a first distance, and the first distance is less than a distance between the display unit and the eyes of the user; acquiring, by the image acquisition unit, an image of action of touching the virtual 3D control picture by the user; judging a touch position of the user in the virtual 3D control picture according to the image acquired by the image acquisition unit, and sending a control instruction corresponding to the touch position to a corresponding execution unit.

### FIELD OF THE INVENTION

The present invention belongs to the field of gesture recognition technology, and particularly to a display device and a control method thereof, and a gesture recognition method.

### BACKGROUND OF THE INVENTION

With the development of technology, it has been possible to control a display device (a TV set, a display, etc.) by gestures. The display device having a gesture recognition function comprises a display unit for displaying and an image acquisition unit (a camera, a digital camera, etc.) for acquiring gestures. By analyzing the image acquired by the image acquisition unit, an operation to be performed by a user may be determined.

In the present gesture recognition technology, “select” and “confirm” operations have to be performed by different gestures, respectively, so that the operations are troublesome. For example, if the channel of a TV set is changed by gestures, it is required to select a channel by a first gesture (e.g., waving a hand from left to right), the channel is changed once every time the hand is waved. When a correct channel is selected, the channel is accessed by a second gesture (e.g., waving a hand from top to bottom). In other words, the gesture recognition technology of an existing display device cannot realize the operation in which “select” is integrated with “confirm”, that is, unlike a tablet computer, an instruction to be executed cannot be selected and executed by only “touching” a certain one of a plurality of candidate icons. The reason is because a touch position should be accurately judged for the “touch” operation. For a tablet computer, if a hand directly touches a screen, it is available to determine a touch position by a touch technology. However, for the gesture recognition technology, a hand generally cannot touch a display unit (particularly for a TV set, a user is far away from the TV display screen during normal use), but can only “point to” a certain position of the display unit (e.g., a certain icon displayed by the display unit). The accuracy of such long-distance “pointing” is very poor. When the same position of the display unit is pointed to, gestures of different users may be different. Some persons point to left, while some persons point to right, and thus where the user wants to point to on earth cannot be determined, so that the “touch” operation cannot be realized.

### SUMMARY OF THE INVENTION

In view of the problem that “select” and “confirm” operations must be performed separately in the existing gesture recognition, a technical problem to be solved by the present invention is to provide a display device and a control method thereof, and a gesture recognition method, by which the “select” and “confirm” operations may be completed in one step by gesture recognition.

A technical solution employed to solve the technical problem to be solved by the present invention is a control method of a display device, comprising steps of: displaying a control picture by a display unit, converting, by a 3D unit, the control picture into a virtual 3D control picture, and providing the virtual 3D control picture to a user, wherein the 3D unit comprises a pair of 3D glasses, and a virtual distance between the virtual 3D control picture and eyes of the user is a first distance, the first distance is less than a distance between the display unit and the eyes of the user; acquiring, by an image acquisition unit, an image of action of touching the virtual 3D control picture by the user; and, judging, by a gesture recognition unit, a touch position of the user in the virtual 3D control picture according to the image acquired by the image acquisition unit, and sending a control instruction corresponding to the touch position to a corresponding execution unit.

Preferably, the first distance is less than or equal to a length of an arm of the user.

Preferably, the first distance is less than or equal to 0.5 m but greater than or equal to 0.25 m.

Preferably, the virtual 3D control picture spreads throughout a whole display picture used for displaying the virtual 3D control picture; or, the virtual 3D control picture is a part of the display picture used for displaying the virtual 3D control picture.

Preferably, the virtual 3D control picture is divided into at least two regions, each of which corresponds to one control instruction.

Preferably, before judging, by the gesture recognition unit, a touch position of the user in the virtual 3D control picture according to the image acquired by the image acquisition unit, the control method further comprises: determining, by a positioning unit, a position of the user with respect to the display unit; the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

Further preferably, the step of determining, by a positioning unit, a position of the user with respect to the display unit comprises: analyzing, by the positioning unit, the image acquired by the image acquisition unit to determine the position of the user with respect to the display unit.

A technical solution employed to solve the technical problem to be solved by the present invention is a display device, comprising: a display unit that is configured to perform display; a 3D unit comprising a pair of 3D glasses, which is configured to convert a control picture displayed by the display unit into a virtual 3D control picture and provide the virtual 3D control picture to a user, wherein a virtual distance between the virtual 3D control picture and eyes of the user is a first distance, the first distance is less than a distance between the display unit and the eyes of the user; an image acquisition unit that is configured to acquire an image of action of touching the virtual 3D control picture by the user; and a gesture recognition unit that is configured to judge a touch position of the user in the virtual 3D control picture according to the image acquired by the image acquisition unit and send a control instruction corresponding to the touch position to a corresponding execution unit.

Preferably, the display unit is a TV display screen or a computer display screen.

Preferably, the 3D unit further comprises a 3D polarizing film provided outside of display surface of the display unit.

Preferably, the display device further comprises: a positioning unit that is configured to determine a position of the user with respect to the display unit.

Further preferably, the positioning unit is configured to analyze the image acquired by the image acquisition unit to determine the position of the user with respect to the display unit.

A technical solution employed to solve the technical problem to be solved by the present invention is a gesture recognition method, comprising steps of: displaying a control picture by a display unit, converting, by a 3D unit, the control picture into a virtual 3D control picture, and providing the virtual 3D control picture to a user, wherein the 3D unit comprises a pair of 3D glasses, and a virtual distance between the virtual 3D control picture and eyes of the user is a first distance, the first distance is less than a distance between the display unit and the eyes of the user; acquiring, by an image acquisition unit, an image of action of touching the virtual 3D control picture by the user; and judging, by a gesture recognition unit, a touch position of the user in the virtual 3D control picture according to the image acquired by the image acquisition unit, and sending a control instruction corresponding to the touch position to a corresponding execution unit.

Wherein, the “3D unit” is capable of converting a two-dimensional image displayed by the display unit into a 3D image with stereoscopic effect (of course, the display unit is required to display certain contents for co-ordination), and comprises a pair of 3D glasses for user's wearing.

Wherein, the “virtual 3D control picture” refers to a stereoscopic control picture converted by the 3D unit, and the control picture is used for realizing control.

Wherein, the “virtual distance” refers to a distance from the virtual 3D control picture sensed by the user to the user. The sense of distance is a part of the stereoscopic sense, and is caused by a difference between the images watched by left and right eyes. Thus, by converting through the 3D unit, the user may sense that the virtual 3D control picture is located at a position with a certain distance in front of the user, as long as the display unit displays certain contents, and even if the user is far away or close to the display unit, the distance between the virtual 3D control picture sensed by the user and the user himself/herself is always the same.

Wherein, the “execution unit” refers to any unit capable of executing a corresponding control instruction. For example, for a channel changing instruction, the execution unit is a display unit, while for a volume changing instruction, the execution unit is a sounding unit.

In the display device and control method thereof, and the gesture recognition method provided by the present invention, the display unit may present a virtual 3D control picture for a user, and the distance from the virtual 3D control picture to the user is less than the distance between the display unit and the user, thus the user will sense that the control picture is close to himself/herself (in front of himself/herself) and thus may accurately “touch” the virtual 3D control picture by directly stretching out his or her hand. Accordingly, the actions of different users touching a same position of the virtual 3D control picture are identical or similar, so that the gesture recognition unit may accurately judge a touch position desired by the user, and the “touch” operation in which “select” is integrated with “confirm” is thus realized.

The present invention is used for controlling a display device, and particularly suitable for the control of a TV set.

### BRIEF DESCRIPTION OF THE DRAWINGS

FIG. 1 is a flowchart of a control method of a display device according to a first embodiment of the present invention.

FIG. 2 is a schematic diagram when the display device according to the first embodiment of the present invention displays a virtual 3D control picture.

Reference numerals: 1-Display unit; 2-3D glasses; 3-Hand of a user; 4-Virtual 3D control picture; 5-Image acquisition unit.

### DETAILED DESCRIPTION OF THE EMBODIMENTS

To make those skilled in the art better understand the technical solutions of the present invention, the present invention will be further described below in detail in conjunction with the accompanying drawings and specific embodiments.

### First Embodiment

This embodiment provides a control method of a display device. The display device, for which the control method is suitable, comprises a display unit, a 3D unit, an image acquisition unit and a gesture recognition unit, and preferably further comprises a positioning unit.

The display unit is any display equipment capable of displaying a 2D picture, such as liquid crystal display equipment, organic light-emitting diode display equipment, etc.

Preferably, the display unit is a TV display screen. As a person needs to perform relatively frequent operations (e.g., changing a channel, adjusting volume, etc.), and a user is at a distance far away from a TV set in general and it is difficult to control the TV set by touching or in other manners, the present invention is more applicable to TV sets. Of course, it is also feasible that the display unit is a computer display screen or other equipment.

The 3D unit refers to a device capable of converting a two-dimensional image displayed by the display unit into a 3D image with stereoscopic effect, and comprises a pair of 3D glasses for user's wearing. In case that the 3D unit only comprises a pair of 3D glasses, the 3D glasses may be 3D shutter glasses, that is, the left and right lenses may be enabled alternatively (for example, switched per frame of image) so that the left and right eyes of the user see different images, thus a 3D effect is achieved.

Alternatively, preferably, the 3D unit may also comprise a pair of 3D glasses and a 3D polarizing film provided outside of display surface of the display unit. The 3D polarizing film can convert the light from different positions of the display unit into polarized light with different polarization directions. In this case, the left and right lenses of the 3D glasses are different polarizing lenses, so that the polarized light passing through the 3D polarizing film can be filtered differently, and the left and right eyes of the user can see different images. Since there are many methods for realizing a 3D display by 3D glasses, the descriptions thereof will not be given one by one.

The image acquisition unit is configured to acquire images of the user, and may be a CCD (Charge Coupling Device) camera, a digital camera or other known devices. For convenience, the image acquisition unit may be provided near the display unit (for example, fixed above or by the side of the display unit), or the image acquisition unit and the display unit are integrated into a whole structure.

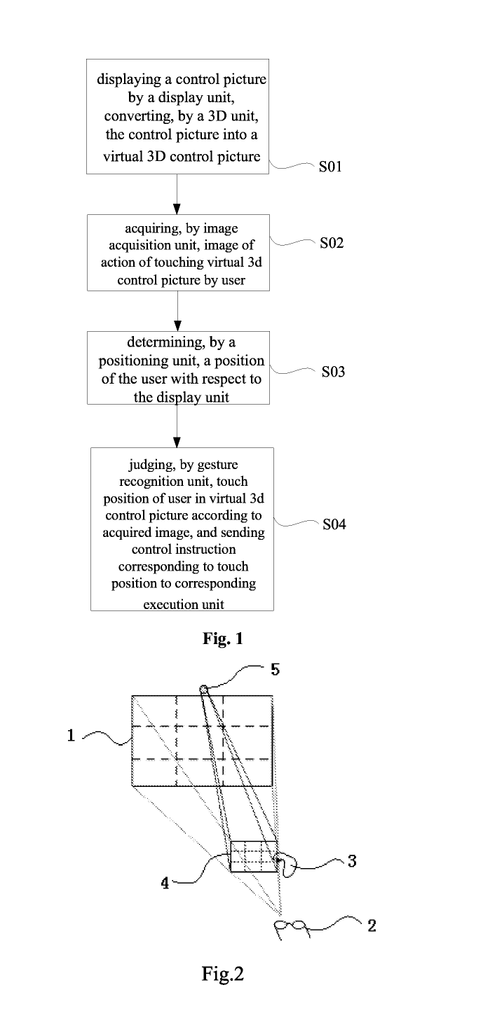

Specifically, as shown in FIG. 1, the control method comprises the following steps S01 through S04.

S01: Displaying, by the display unit, a control picture, converting, by the 3D unit, the control picture into a virtual 3D control picture, and providing the virtual 3D control picture to a user, wherein the virtual distance between the virtual 3D control picture and the eyes of the user is a first distance, and the first distance is less than the distance between the display unit and the eyes of the user.

In this step, the control picture refers to a picture used specially for control operations of a display device, including various control instructions for a display device. By selecting different control instructions, a user may realize different controls of the display device.

As shown in FIG. 2, the display unit 1 displays a control picture, and the 3D unit comprising the 3D glasses 2 converts the control picture into a stereoscopic virtual 3D control picture 4 and allows the user to sense that the virtual 3D control picture 4 is located at a certain distance (a first distance) in front of the user, and the first distance is less than the distance from the display unit 1 to the user. As the user senses that the virtual 3D control picture 4 is relatively close to the user himself or herself, the user may do an action of accurately “touching” a certain position of the picture by stretching out his or her hand 3, so that the display device may also more accurately judge which operation is to be performed by the user, thereby realizing “touch” control.

Preferably, the first distance is less than or equal to the length of an arm of a user. When the first distance is less than or equal to the length of an arm of a user, the user senses that he or she may “touch” the virtual 3D control picture 4 by stretching out his or her hand, so that the accuracy of a touch action may be ensured to the largest extent.

Preferably, the first distance is less than or equal to 0.5 m but greater than or equal to 0.25 m. In accordance with the range of the first distance, the great majority of people do not need to straighten their arms in an effort to “reach” the virtual 3D control picture 4, and will not sense that the virtual 3D control picture 4 is too close to him or her.

Preferably, the virtual 3D control picture 4 spreads throughout a whole display picture used for displaying the virtual 3D control picture. That is to say, while displaying the virtual 3D control picture 4, the virtual 3D control picture 4 is the whole displaying content, and the user only can see the virtual 3D control picture 4, so that the area of the virtual 3D control picture 4 is relatively large and can include more control instructions to be selected, and the accuracy of touching is relatively high.

Preferably, as another implementation of the present embodiment, the virtual 3D control picture 4 may also be a part of the whole display picture used for displaying the virtual 3D control picture 4. That is to say, the virtual 3D control picture 4 is displayed at the same time as a conventional picture (such as a telecast), the virtual 3D control picture 4 seen by the user may be located at an edge or a corner of the display picture, so that the user can see the conventional picture and the virtual 3D control picture 4 simultaneously so as to perform control (for example, to adjust the volume or switch the channel) at any time.

Preferably, when the virtual 3D control picture 4 spreads throughout the whole display picture used for displaying the virtual 3D control picture 4, under a certain condition (for example, when the user sends out the instruction), the virtual 3D control picture 4 is displayed, and in other cases, the conventional picture is still displayed. When the virtual 3D control picture 4 is a part of the whole display picture used for displaying the virtual 3D control picture 4, it may be always displayed.

Preferably, the virtual 3D control picture 4 is divided into at least two regions, each of which corresponds to one control instruction. In other words, the virtual 3D control picture 4 may be divided into a plurality of different regions. By touching different regions, different control instructions may be executed, so that a plurality of different operations may be performed by one virtual 3D control picture 4. For example, as shown in FIG. 2, the virtual 3D control picture 4 may be equally divided into 9 rectangular regions in 3 rows×3 columns, and each of the rectangular regions corresponds to one control instruction (e.g., changing volume, changing the channel, changing brightness, quitting the virtual 3D control picture 4, etc.).

Of source, it is also feasible that the virtual 3D control picture 4 corresponds to only one control instruction (for example, the virtual 3D control picture 4 is a part of the display picture used for displaying the virtual 3D control picture 4, and the corresponding instruction thereof is “entering the control picture of full screen”).

Of course, in the present invention, only the control picture should be converted into a 3D form, and the conventional picture (such as a telecast) may be still in a 2D form. For example, when the user is looking at the conventional picture, he or she may not wear the 3D glasses 2, or the two lenses of the 3D glasses 2 wore by the user may be enabled simultaneously, or the left and right images displayed by the display unit 1 are the same with each other.

S02: Acquiring, by the image acquisition unit, an image of action of touching the virtual 3D control picture by the user.

As shown in FIG. 2, the image acquisition unit 5 fixed above the display unit 1 acquires the image of action of touching the virtual 3D control picture 4 by the hand 3 of the user. In other words, when the display unit 1 displays the control picture and the 3D unit converts the control picture into the virtual 3D control picture 4 and provides the virtual 3D control picture 4 to the user, the image acquisition unit 5 is enabled to acquire the image of the action of the user, particularly to acquire the image of action of touching the virtual 3D control picture 4 by the hand 3 of the user.

Of course, when there is no control picture displayed, the image acquisition unit 5 may also be enabled to acquire images of other gestures of the user or to determine the position of the user.

S03: Optionally, judging, by the positioning unit, the position (distance and/or angle) of the user with respect to the display unit.

Obviously, when the position of the user with respect to the display unit 1 is changed, although the control action is unchanged for the user (is still the action of touching the virtual 3D control picture 4 in front of the user), but for the image acquisition unit 5, the acquired image is changed. Thus, preferably, the relative position relationship between the user and the display unit 1 can be predetermined first, so that an accurate recognition can be achieved in the gesture recognition procedure.

Specifically, as a preferable implementation, the position of the user with respect to the display unit 1 can be determined by the position unit (not shown in the figures) through analyzing the image acquired by the image acquisition unit 5. For example, when the virtual 3D control picture 4 is displayed, the first image acquired by the image acquisition unit 5 can be used for determining the position of the user with respect to the display unit 1, and the subsequent acquired image is used for gesture recognition. There are various methods for determining the position of the user with respect to the display unit 1 in accordance with the acquired image. For example, the user's body contour or the contour of the 3D glasses 2 may be determined by a contour analysis so as to further determine the position of the user, or a tag may be provided on the 3D glasses 2 so that the position of the user can be determined by tracking the tag.

Of course, there are many other methods for determining the position of the user with respect to the display unit 1. For example, two infrared range finders may be provided at two different positions, so that the position of the user is calculated by distances from the user to the two infrared range finders respectively measured by the infrared range finders.

Of course, it is also feasible that the above positioning determination is not performed. For example, if the position of the user with respect to the display unit 1 is relatively fixed (for example, the user is accustomed to sit at 5 meters away from and directly in front of the display unit 1), the position of the user may be default.

S04: Judging, by the gesture recognition unit, a touch position of the user in the virtual 3D control picture according to the image acquired by the image acquisition unit (and the position of the user with respect to the display unit), and sending a control instruction corresponding to the touch position to a corresponding execution unit.

As described above, the position of the user with respect to the display unit 1 is known, and the virtual 3D control picture 4 is located at a certain distance in front of the user, as shown in FIG. 2, the spatial position of the virtual 3D control picture 4 with respect to the display unit 1 may be determined by the gesture recognition unit (not shown in the figure) because the virtual 3D control picture 4 must be located on the connection line between the display unit 1 and the user. Meanwhile, when the user stretches his or her hand 3 to touch the virtual 3D control picture 4, the gesture recognition unit may also determine the touched spatial position (i.e., the position of the hand 3) in accordance with the acquired image (wherein, the position of the image acquisition unit 5 with respect to the display unit 1 is also known) so as to further determine the position in the virtual 3D control picture 4 corresponding to the touched position, that is, to determine the control instruction corresponding to the gesture of the user. Then, the gesture recognition unit can send the control instruction to a corresponding execution unit. The execution unit performs the instruction to realize control.

In this step, the “execution unit” refers to any unit capable of executing a corresponding control instruction. For example, for a channel changing instruction, the execution unit is a display unit, while for a volume changing instruction, the execution unit is a sounding unit.

As described above, if the position of the user with respect to the display unit 1 is not determined (that is, the step S03 is not performed), the position of the user may be determined according to default, or, the position to be touched by the user may be determined in accordance with the relative position relationship between the body and the hand of the user, because the relative position relationship between the virtual 3D control picture 4 and the user is known.

The embodiment of the present invention further provides a display device controlled by using the method described above, comprising: a display unit 1 for displaying; a 3D unit comprising a pair of 3D glasses 2, that is configured to convert the control picture displayed by the display unit 1 into a virtual 3D control picture 4 and provide the virtual 3D control picture 4 to a user, wherein the virtual distance between the virtual 3D control picture 4 and the eyes of the user is a first distance, and the first distance is less than the distance between the display unit 1 and the eyes of the user; an image acquisition unit 5 that is configured to acquire an image of action of touching the virtual 3D control picture 4 by the user; and a gesture recognition unit that is configured to judge a touch position of the user in the virtual 3D control picture 4 according to the image acquired by the image acquisition unit 5 and send a control instruction corresponding to the touch position to a corresponding execution unit.

Preferably, the display unit 1 is a TV display screen or a computer display screen.

Preferably, the 3D unit further comprises a 3D polarizing film provided outside of display surface of the display unit 1.

Preferably, the display device further comprises: a positioning unit that is configured to determine a position of the user with respect to the display unit 1.

Further preferably, the positioning unit is configured to analyze the image acquired by the image acquisition unit 5 to determine the position of the user with respect to the display unit 1.

### Second Embodiment

This embodiment provides a gesture recognition method, comprising the following steps of: displaying a control picture by a display unit, converting, by a 3D unit, the control picture into a virtual 3D control picture and providing the virtual 3D control picture to a user, wherein the 3D unit comprises a pair of 3D glasses, the virtual distance between the virtual 3D control picture and the eyes of the user is a first distance, and the first distance is less than the distance between the display unit and the eyes of the user; acquiring, by an image acquisition unit, an image of action of touching the virtual 3D control picture by the user; and, judging, by a gesture recognition unit, a touch position of the user in the virtual 3D control picture according to the image acquired by the image acquisition unit, and sending a control instruction corresponding to the touch position to a corresponding execution unit.

In other words, the gesture recognition method described above is not limited for controlling a display device, and may also be used for controlling other devices, as long as the gesture recognition unit sends a control instruction to a corresponding device (e.g., in a wireless manner). For example, a TV set, a computer, an air conditioner, a washing machine and other devices may be controlled uniformly by a special gesture recognition system.

It should be understood that, the forgoing implementations are merely exemplary implementations used for describing the principle of the present invention, but the present invention is not limited thereto. A person of ordinary skill in the art may make various variations and improvements without departing from the spirit and essence of the present invention, and these variations and improvements are also deemed as falling within the protection scope of the present invention.

1-13. (canceled)

14. A control method of a display device, comprising steps of:
displaying a control picture by a display unit, converting, by a 3D unit, the control picture into a virtual 3D control picture and providing the virtual 3D control picture to a user, wherein the 3D unit comprises a pair of 3D glasses, a virtual distance between the virtual 3D control picture and eyes of the user is a first distance, and the first distance is less than a distance between the display unit and the eyes of the user;
acquiring, by the image acquisition unit, an image of action of touching the virtual 3D control picture by the user; and
judging, by the gesture recognition unit, a touch position of the user in the virtual 3D control picture according to the image acquired by the image acquisition unit, and sending a control instruction corresponding to the touch position to a corresponding execution unit.

15. The control method of a display device according to claim 14, wherein,
the first distance is less than or equal to a length of an arm of the user.

16. The control method of a display device according to claim 14, wherein,
the first distance is less than or equal to 0.5 m but greater than or equal to 0.25 m.

17. The control method of a display device according to claim 14, wherein,
the virtual 3D control picture spreads throughout a whole display picture used for displaying the virtual 3D control picture; or,
the virtual 3D control picture is a part of the display picture used for displaying the virtual 3D control picture.

18. The control method of a display device according to claim 14, wherein,
the virtual 3D control picture is divided into at least two regions, each of which corresponds to one control instruction.

19. The control method of a display device according to claim 14, wherein,
before the step of judging, by the gesture recognition unit, a touch position of the user in the virtual 3D control picture according to the image acquired by the image acquisition unit, the control method further comprises: determining, by a positioning unit, a position of the user with respect to the display unit;
the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

20. The control method of a display device according to claim 15, wherein,
before the step of judging, by the gesture recognition unit, a touch position of the user in the virtual 3D control picture according to the image acquired by the image acquisition unit, the control method further comprises: determining, by a positioning unit, a position of the user with respect to the display unit;
the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

21. The control method of a display device according to claim 16, wherein,
before the step of judging, by the gesture recognition unit, a touch position of the user in the virtual 3D control picture according to the image acquired by the image acquisition unit, the control method further comprises: determining, by a positioning unit, a position of the user with respect to the display unit;
the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

22. The control method of a display device according to claim 17, wherein,
before the step of judging, by the gesture recognition unit, a touch position of the user in the virtual 3D control picture according to the image acquired by the image acquisition unit, the control method further comprises: determining, by a positioning unit, a position of the user with respect to the display unit;
the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

23. The control method of a display device according to claim 18, wherein,
before the step of judging, by the gesture recognition unit, a touch position of the user in the virtual 3D control picture according to the image acquired by the image acquisition unit, the control method further comprises: determining, by a positioning unit, a position of the user with respect to the display unit;
the step of judging, by the gesture recognition unit, a touch position of the user in the virtual 3D control picture according to the image acquired by the image acquisition unit comprises: judging, by the gesture recognition unit, a touch position of the user in the virtual 3D control picture according to the image acquired by the image acquisition unit and the position of the user with respect to the display unit.

24. The control method of a display device according to claim 19, wherein,
the step of determining, by a positioning unit, a position of the user with respect to the display unit comprises:
analyzing, by the positioning unit, the image acquired by the image acquisition unit to determine the position of the user with respect to the display unit.

25. A display device, comprising:
a display unit that is configured to perform display;
a 3D unit comprising a pair of 3D glasses, that is configured to convert a control picture displayed by the display unit into a virtual 3D control picture and provide the virtual 3D control picture to a user, wherein a distance between the virtual 3D control picture and eyes of the user is a first distance, and the first distance is less than a distance between the display unit and the eyes of the user;
an image acquisition unit that is configured to acquire an image of action of touching the virtual 3D control picture by the user; and
a gesture recognition unit that is configured to judge a touch position of the user in the virtual 3D control picture according to the image acquired by the image acquisition unit and send a control instruction corresponding to the touch position to a corresponding execution unit.

26. The display device according to claim 25, wherein,
the display unit is a TV display screen or a computer display screen.

27. The display device according to claim 25, wherein,
the 3D unit further comprises a 3D polarizing film provided outside of display surface of the display unit.

28. The display device according to claim 25, further comprises:
a positioning unit that is configured to determine a position of the user with respect to the display unit.

29. The display device according to claim 26, further comprises:
a positioning unit that is configured to determine a position of the user with respect to the display unit.

30. The display device according to claim 27, further comprises:
a positioning unit that is configured to determine a position of the user with respect to the display unit.

31. The display device according to claim 28, wherein,
the positioning unit is configured to analyze the image acquired by the image acquisition unit to determine the position of the user with respect to the display unit.

32. A gesture recognition method, comprising steps of:
displaying a control picture by a display unit, converting, by a 3D unit, the control picture into a virtual 3D control picture and providing the virtual 3D control picture to a user, wherein the 3D unit comprises a pair of 3D glasses, a distance between the virtual 3D control picture and eyes of the user is a first distance, and the first distance is less than a distance between the display unit and the eyes of the user;
acquiring, by an image acquisition unit, an image of action of touching the virtual 3D control picture by the user; and
judging, by a gesture recognition unit, a touch position of the user in the virtual 3D control picture according to the image acquired by the image acquisition unit, and sending a control instruction corresponding to the touch position to a corresponding execution unit.
